(19) United States
(12) Patent Application Publication
(10) Pub. No.: US 2009/0144561 A1
(43) Pub. Date: Jun. 4, 2009

(54) Method and System for Software Protection Using Binary Encoding

(76) Inventors: Jack W. Davidson, Charlottesville, VA (US); Anh Nguyen-Tuong, Charlottesville, VA (US); Jonathan C. Rowanhill, Freemont, CA (US); David E. Evans, Charlottesville, VA (US); John C. Knight, Charlottesville, VA (US); Adrian T. Filipi, Charlottesville, VA (US); Jason Hiser, Charlottesville, VA (US); Wei Hu, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 11/995,272

(22) PCT Filed: Jul. 11, 2006
(86) PCT No.: PCT/US2006/026932

§ 371 Date: Feb. 29, 2008

Related U.S. Application Data
(60) Provisional application No. 60/698,137, filed on Jul. 11, 2005.

(51) Int. Cl. G06F 11/00

(52) U.S. Cl. 713/190

(57) ABSTRACT

Software is protected by encoding the target software instructions and decoding the target instructions.

### CROSS-REFERENCE TO RELATED APPLICATIONS

This US patent application claims priority from co-pending U.S. provisional application Ser. No. 60/698,137 to Davidson et al., field on Jul. 11, 2005, the subject matter of which is incorporated herein by reference in its entirety.

The subject matter of each one of the following publications is incorporated herein by reference in its entirety:
1) “Control-Flow Integrity” Abadi, M., M. Budiu, et al., Microsoft Technical Report MSR-TR_{—}05-18, 2005;
2) “Randomized Instruction Set Emulation to Disrupt Binary Code Injection Attacks” Barrantes, E. G., D. H. Ackley, et al., ACM Conference on Computer and Communications Security 2003;
3) “Randomized instruction set emulation” Barrantes, E. G., D. H. Ackley, et al. ACM Transactions on Information System Security 8(1): 3-40;
4) “Linktime optimization of ARM Binaries Bus”, B. D., B. D. Sutter, et al., ACM SIG-PLAN Notices 39(7): 211-220, (2004);
5) “Watermarking, tamper-proofing, and obfuscation—tools for software protection”, Collberg, C. S. and C. Thomborson, IEEE Transactions on Software Engineering 28: 735-746 (2002);
6) “FormatGuard: Automatic Protection From print Format String Vulnerabilities” Cowan, C., M. Barringer, et al., USENIX Security Symposium (2001);
7) “StackGuard: Automatic adaptive detection and prevention of buffer-overflow attacks” Cowan, C., C. Pu, et al., 7th USENIX Security Conference (1998);
8) “Algorithm alley: Rijndael: The Advanced Encryption Standard” Daemen, J. and V. Rijmen, Dr. Dobb's Journal of Software Tools 26(3): 137-139 (2001);
9) “Static Detection of Dynamic Memory Errors” Evans, D. (1996), ACM SIGPLAN Conference on Programming Language Design and Implementation (2001);
10) “Building Diverse Computer Systems” Forrest, S., A. Somayaji, et al. Sixth Workshop on Hot Topics in Operating Systems (1997);
11) Countering Code-Injection Attack With Instruction-Set Randomization” Kc, G. S., A. D. Keromytis, et al. ACM Computer and Communication Security (CCS) (2003);
12) “Secure Execution Via Program Shepherding” Kiriansky, V., D. Bruening, et al. 11th Usenix Security Symposium (2002);
13) “Statically Detecting Likely Buffer Overflow Vulnerabilities” Larochelle, D. and D. Evans, USENIX Security Symposium (2001);
14) “Dynamic binary analysis and instrumentation” Nethercote, N., Technical Report UCAM-CL-TR-606, University of Cambridge, Computer Laboratory (2004);
15) “Retargetable and reconfigurable software dynamic translation” Scott, K., N. Kumar, et al. International Symposium on Code Generation and Optimization (2003); and
16) “Where's the FEEB? The Effectiveness of Instruction Set Randomization” Sovarel, A. N., D. Evans, et al., 14th Usenix Security Symposium, Baltimore (2005).
17) “A Survey of Anti-Tamper Technologies”, Atallah, M., E. Bryant, and M. Stytz, CrossTalk: The Journal of Defense Software Engineering, November (2004).
18) Government Accounting Office, DOD Needs to Better Support Program Managers' Implementation of Anti-Tamper Protection, GAO-04-302, March (2004).

### TECHNICAL FIELD OF THE INVENTION

The present invention relates to the art of software protection, and more particularly, to the art of software protection using binary encoding.

### BACKGROUND OF THE INVENTION

Today's networked computer systems have greatly increased productivity as well as quality of life. The ubiquity and reliance on computer systems to control vital infrastructure (e.g. transportation systems, communication systems, financial systems, defense systems, etc.) and to serve as a common appliance for carrying out life's everyday tasks (e.g., shopping, education, communicating with friends and relatives, entertainment, etc.) has made protecting these systems a priority. To underscore the vulnerability of the software infrastructure, an average of 50 security vulnerabilities are discovered weekly. A virulent computer virus or worm, undetected and unchecked, could wreak havoc on such infrastructure.

Computing monoculture is one of the major culprits for the fragile software infrastructure. The respective market for operating systems, routers, firewalls, cable modems, servers, browsers and other clients, media players, and embedded systems, (to name only a few examples) is dominated by a handful of providers. A promising approach inspired by biology is to use diversity to combat this monoculture. Just as a genetically diverse population potentially protects species from widespread diseases, a diverse software population would protect against widespread attacks on our cyber infrastructure. If each copy of a software application were different enough, an attacker would need to craft a separate and tailored attack for each copy, thereby greatly increasing the difficulty of mounting a successful attack for at least two reasons: (1) it would make it harder to mount an attack on a single application; and (2) it would make it harder to mount an automated and/or self-propagating attack, e.g., a worm that successfully subverts an application and uses the subverted application to attack other applications.

One way of preventing attack is to write software without faults, i.e., without defects in the software, as some faults represent security vulnerabilities, e.g., buffer overflows. However, despite decades of research and progress in software engineering practices, applications are still shipped today with numerous faults. Some of these faults represent security vulnerabilities waiting to be exploited. One approach towards reducing the number of vulnerabilities is to perform static analysis on the source code (such as that disclosed in Evans 1996, Larochelle and Evans 2001), and warn developers of potential vulnerabilities. Another is to write applications in a type-safe language such as Java or C# language in which certain classes of security vulnerabilities are prevented. Other possible techniques defend against specific attacks (such as that disclosed in Cowan, Pu et al. 1998; Cowan, Barringer et al. 2001). Yet other techniques provide protection by detecting deviation from an application's normal behavior (Abadi, Budiu et al. 2005) or by constraining the behavior of applications (Kiriansky, Bruening et al. 2002). Yet others seek to introduce diversity in software (Forrest, Somayaji et al. 1997; Barrantes, Ackley et al. 2003; Kc, Keromytis et al. 2003; Barrantes, Ackley et al. 2005).

One diversity technique, instruction set randomization (ISR) (Kc, Keromytis et al. 2003; Barrantes, Ackley et al. 2005), seeks to protect software by randomizing the instruction set of software applications and invalidating the attacker's knowledge of the application's instruction set. Using ISR, even if an attacker is successful in injecting code into an application, the attacker would not be able to execute this code as it will not be understood (since the application under ISR now speaks a “different language”). Advantages of ISR are that it is a generic defense technique that protects software against both known and unknown code-injection attacks provided the attacker cannot guess or obtain the randomizing key(s); and it can be deployed without needing access to source code.

However, ISR suffers from several critical deficiencies. Under ISR, injected code attacks can result in the execution of random instruction sequences (Barrantes, Ackley et al. 2005). The assumption is that the execution of such sequences will eventually fail without doing any damage. Such an assumption may not be correct, and furthermore, while the attack did not succeed in gaining control of the application, the attack will cause the application to fail or fault in some unknown way. A second deficiency is that for performance reasons, current implementations of ISR use simple encode/decode mechanisms such as XOR operation. The ostensible reason is that stronger encryption methods would incur too much runtime overhead. Unfortunately, recent research has shown that these simple schemes can be cracked even when used with a one-time pad (Sovarel, Evans et al. 2005). A third deficiency is that the proposed systems rely on emulation and incur significant runtime overhead costs that make the use of ISR impractical for many applications.

What is desired are improved methods and systems for protecting software.

### SUMMARY OF THE INVENTION

The objects and advantages of the present invention will be obvious, and in part appear hereafter and are accomplished by the present invention that provides a method and system for protecting software using binary encoding.

As an example of the invention, a method for protecting software is disclosed herein. The method comprises: encoding a set of instructions associated with the software using a block encryption technique, wherein the block has more than 8-bits; executing the encoded set of instructions.

As another example of the invention, a method of executing a set of encoded instructions is disclosed herein. The method comprises: loading the set of encoded instructions into a virtual machine, decoding the instructions; and executing the decoded instructions by the virtual machine or a computing device on which the virtual machine is hosted.

As yet another example of the invention, a method is disclosed herein. The method comprises: a first computing device having a first computer-executable instructions for performing a method comprising: encoding a set of instructions associated with the software using a block encryption technique, wherein the block has more than 8-bits; a second computing device having a second computer-executable instructions for performing a method comprising: executing the encoded set of instructions. The first and second computers may or may not be networked.

As yet another example of the invention, a method for protecting software is disclosed herein. The method comprises: retrieving a set of instructions associated with the software; calculating an integrity of at least a portion of the set of instructions; inserting the integrity to the instructions; encoding the instructions and the integrity with an encoding key; and executing the instructions, further comprising: decoding the instructions and integrity; inspecting the integrity; and executing the decoded instructions if the integrity matches the instruction after being decoded.

Such objects of the invention are achieved in the features of the independent claims attached hereto. Preferred embodiments are characterized in the dependent claims. In the claims, only elements denoted by the words “means for” are intended to be interpreted as means plus function claims under 35 U.S.C. §112, the sixth paragraph.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1 is a block diagram showing a system for protecting software according to the invention;

FIG. 2a is a diagram schematically illustrates an example of performing the binary encoding using an ISR technique according to an embodiment of the invention;

FIG. 2b is a diagram schematically illustrates an example of performing the decoding and execution of the encoded instructions with a Strata virtual machine according to an embodiment of the invention;

FIG. 3 demonstratively illustrates a scheme of the decoding buffer after the fetching operation;

FIG. 4 shows runtime overhead of ISR using Advanced Encryption Standard from an exemplary measurement;

FIG. 5 is a diagram illustrated an exemplary computing device in which embodiments of the invention can be implemented; and

FIG. 6 is a diagram schematically illustrates an exemplary network system wherein embodiments of the invention can be implemented.

### DETAILED DESCRIPTION OF EXEMPLARY EMBODIMENTS

This invention provides a method and system for protecting software using binary encoding. In the following, the invention will be discussed in connection with various embodiments. In view of the many possible embodiments to which the principles of this invention may be applied, it should be recognized that the embodiments described herein in connection with the drawings are meant to be illustrative only and should not be taken as limiting the scope of invention. Those of skill in the art will recognize that the illustrated embodiments can be modified in arrangement and detail without departing from the spirit of the invention. The embodiments that will be discussed herein are not mutually exclusive, unless so stated, or if readily apparent to those of ordinary skill in the art.

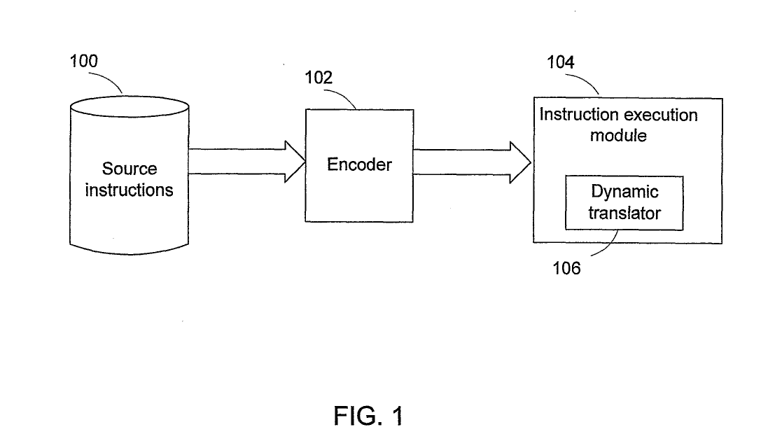

Referring to the drawings, FIG. 1 is a block diagram showing an exemplary system for protecting software according to the invention. The system in this example comprises source instruction storage 100 that stores a set of instructions associated with the software to be protected. Encoder 102 is in communication with the source instruction storage for encoding the instructions with a pre-determined encoding-decoding scheme. Instruction execution module 104 that further comprises a decoder and dynamic translator 106 is connected to the encoder for decoding and executing the instructions.

The source instructions to which the invention is applicable can be binary machine codes (byte codes, and/or generally interpreted codes of any kind) that are executable by a computing device, such as a computer, or can be object code instructions. Encoder 102 is provided to encode the source instructions with a predetermined encryption scheme, such as a block encryption technique with the block having more than 8-bits, more preferably having more than 32 bits. For example, the encoder can be a module using an instruction-set-randomization (ISR) technique. In particular, the encoder can use an Advanced Encryption Standard (hereafter “AES”) technique or “Rijndael” technique as s Daemen and Rijmen 2001, the subject matter of which is incorporated herein by reference. AES is a symmetric algorithm that uses the same security key for both encryption and decryption. AES has been approved by the National Security Agency for secret and top-secret communications and is a de facto standard for commercial software and hardware that uses encryption. AES uses a fixed block size of 128-bits and a 128-bit, 192-bit, or 256-bit security key. Rijndael can be specified with key and block sized in any multiple of 32 bits, with a minimum of 128 bits and a maximum of 256 bits. Longer key lengths provide greater security. Instead of AES or in combination with AES, other encryption techniques, such as techniques that use both symmetric-key and asymmetric-key algorithms are also applicable.

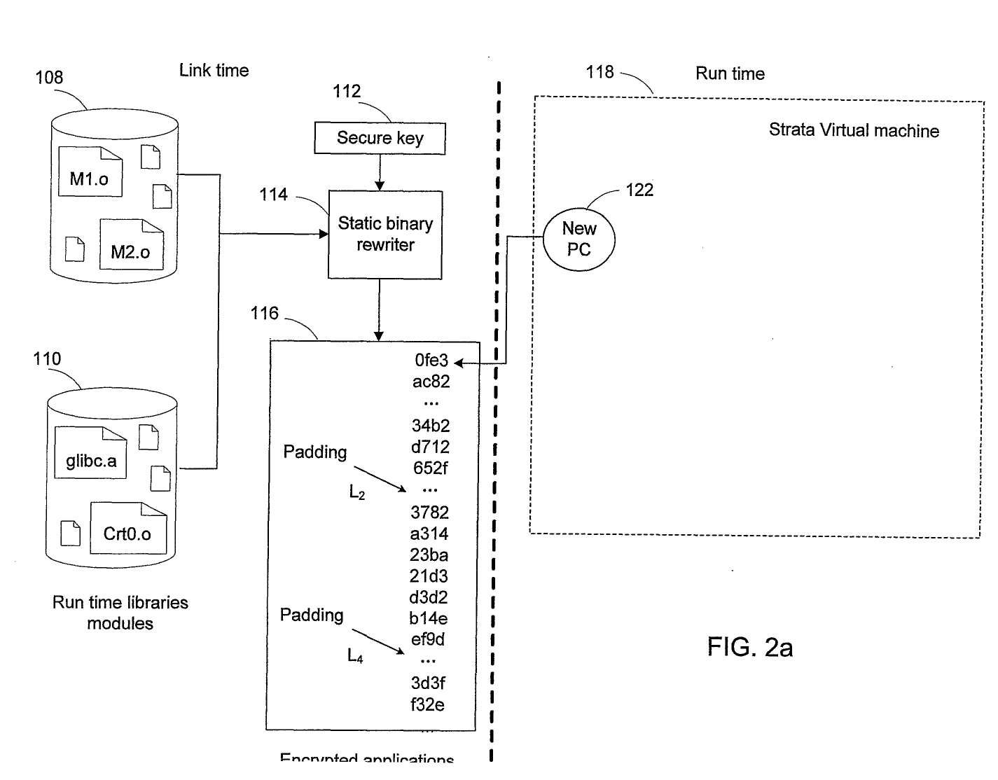

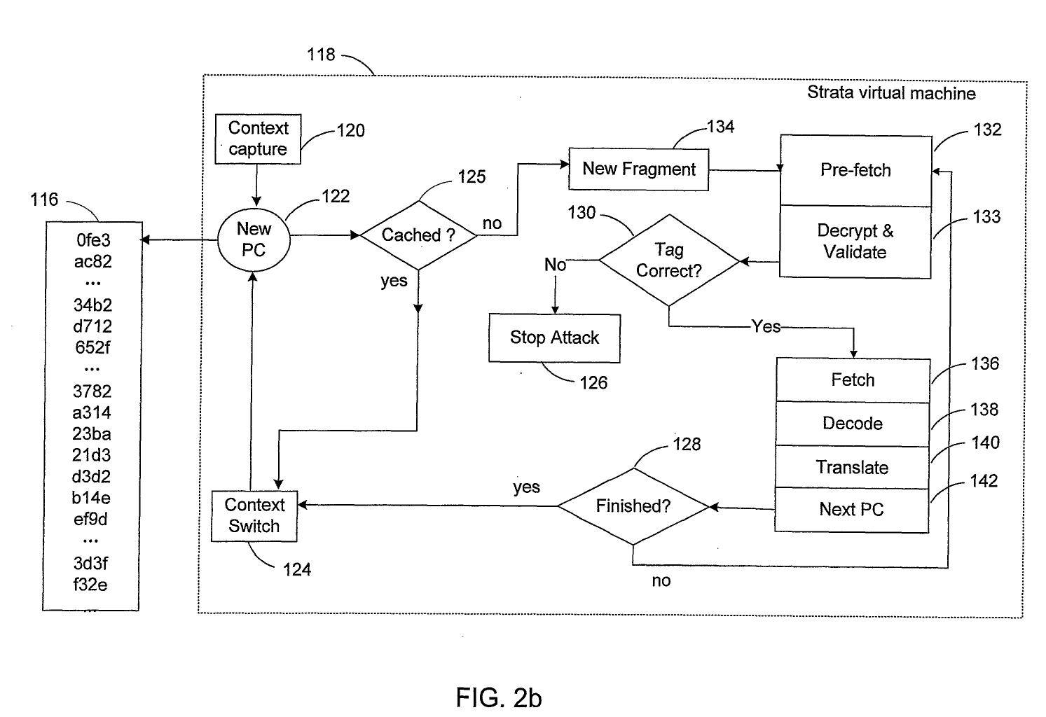

The encoded instructions are passed to instruction execution module 104 wherein the instructions are executed. In an embodiment of the invention, the instruction execution module is a Strata virtual machine and is employed to perform the dynamic decryption, which will be detailed afterwards with reference to FIG. 2b. The decrypted set of instructions can then be executed by the processor of a computing device.

In the following, this invention will be discussed with particular examples wherein embodiments of the invention are implemented in IA-32 architecture; and results are measured under Linux, of course other architectures and operating systems can be used. Without loss of generality, an AES encryption technique with 128 bits security keys that are used for both encoding and decoding the software instructions is employed. A Strata virtual machine, or any other suitable virtual machine, is employed for performing dynamic translation. Specifically, the Strata virtual machine is modified to incorporate a decrypt engine for decoding the instructions. It will be appreciated by those ordinary skill in the art that the following discussion is for demonstration purposes only, and should not be interpreted as a limitation. Instead, other variations without departing from the spirit of the invention are also applicable. For example, embodiments of the invention are also applicable to other architectures. Other security keys with different lengths are also applicable. Moreover, the encoding and decoding may use different security keys, an encryption scheme of which is often referred to as “asymmetric encryption.” In addition to the Strata virtual machine, other type of virtual machines can also be employed, such as Java Virtual machines and common language runtime virtual machines, among others. In addition to an AES encryption technique, other suitable encryption techniques could be utilized, such as Blowfish, CAST, DES, Triple DES, etc.

For demonstration purpose, a block diagram showing an exemplary system for encoding the instructions according to an embodiment of the invention is illustrated in FIG. 2a. An exemplary decoding system for decoding and executing the encoded instructions according to an embodiment of the invention is shown in FIG. 2b.

Referring to FIG. 2a, software instructions are stored in instructions storages 108 and 110 that can be members of source instruction container 100 of FIG. 1. Specifically, instructions associated with the functional modules are stored in storage 108, whereas run time libraries are stored in storage 110. Of course, all instructions associated with the software can be stored in the same storage, which is not illustrated for simplicity.

The instructions are encoded with an AES algorithm, which is accomplished by security key module 112 that generates and/or maintains a security key, static binary rewriter 114, and encrypted application container 116. The AES algorithm, however, requires the instruction chunks to be equal to the size of the security key that is 128-bits in this example. This requirement may not always be satisfied given the variable-size instruction length of the IA-32 architecture, where the length of the instruction can be anywhere from one byte (equal to 8 bits) in length up to 15 bytes. In order to ensure that both encryption and decryption operate on instructions blocks that begin and end at 128-bit boundaries, static binary rewriter 114, such as Diablo as set forth in “Linktime optimization of ARM Binaries Bus”, B. D., B. D. Sutter, et al., ACM SIG-PLAN Notices 39(7): 211-220, (2004), the subject matter of which is incorporated herein by reference in its entirety, is employed; though other tools available to manipulate programs could also be used.

As illustrated in FIG. 2a, static binary rewriter 114, such as Diablo, performs several important functions. Specifically, static binary rewriter 114 retrieves the target instructions from instructions storage 108 and 110, and aligns all branch targets (including function entry points) on 128-bit boundaries. Static binary rewriter 114 accomplishes this by padding the previous basic block with the appropriate number of one-byte no-op instructions that will be removed by dynamic translator 118, such as Strata virtual machine, before executing the corresponding instruction fragments. Static binary rewriter 114 then applies the AES algorithm to the application text and all the libraries required by the application with security key 112. Static binary rewriter 114 may also ensure that dynamic translator 118 (e.g. the Strata virtual machine) and the C language runtime library functions (e.g. glibc.a and crt0.o) it uses are not encrypted. For those library functions that may be needed for both of the dynamic translator and the binary program, a copy of these functions can be made for use of the dynamic translator.

The encoded instructions are passed to an instruction execution module (e.g. execution module 104 in FIG. 1) for being executed. The execution module can be a standard emulator, and more preferably by a virtual machine, such as a Strata virtual machine that incurs much less run time overhead than the emulator. The execution of the encoded and aligned instructions starts from loading the encoded instructions to the Strata virtual machine by locating the program counter 122 of the Strata virtual machine to the memories where the encoded instructions are stored.

An exemplary Strata virtual machine according to an embodiment of the invention is illustrated in FIG. 2b. Referring to FIG. 2b, the Strata virtual machine comprises context capture module 120 that captures and saves the application context (e.g. PC, condition codes, registers, etc.), especially the encoded instructions. The Strata virtual machine begins processing the next application instruction with new PC 122 that points to the corresponding memory wherein the target instruction is located. If a translation of the instruction has been cached (step 125), context switch module (124) restores the application context and begins executing the cached translated instruction on a host processing unit, such as a CPU. If there is no cached translation for the next application instruction, the Strata virtual machine allocates storage in the cache for a new fragment of translated instructions (134). A fragment is referred to as a sequence of codes in which branches may appear only at the end.

To be compatible with the encryption with AES as discussed earlier, a decryption engine capable of decrypting the encoded instructions with the AES is embedded in the Strata virtual machine. In this example, the decryption engine comprises pre-fetch module 132, decrypt and validate module 133, tag inspection module 130, stop attack module 126, and a decoding buffer (not shown in the figure for simplicity) that has 256-bits.

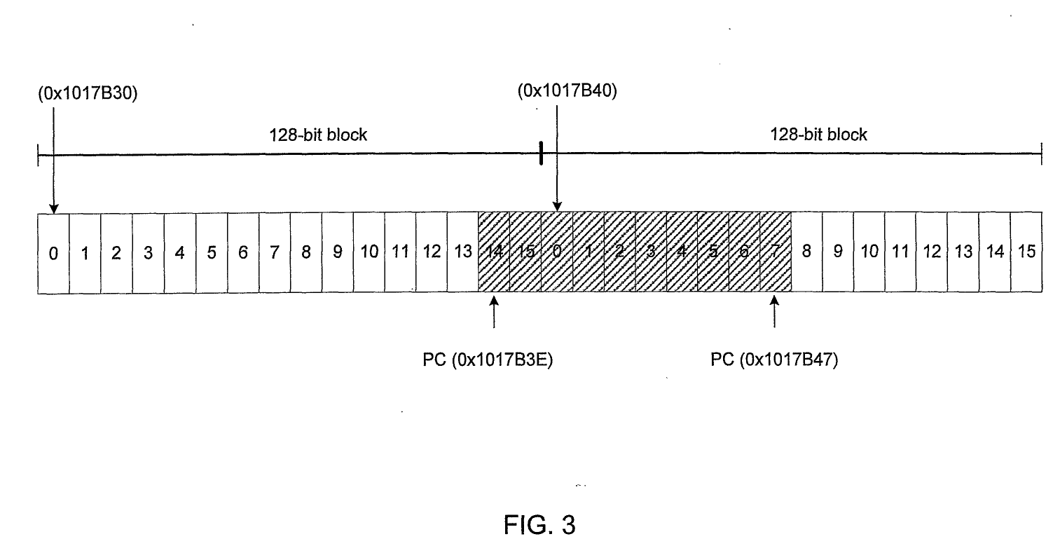

In operation, the pre-fetch module Strata may fetch two consecutive 128-bit blocks into the decoding buffer. Specifically, the pre-fetch module fetches the block that contains the first byte of the instruction and the following 128-bit block. Both blocks are then decrypted at decrypt and validate module 133, which will be detailed with reference to FIG. 3. Fetching two consecutive 128-bit blocks guarantees that the complete instruction is fetched and decoded even if the instruction starts on the last byte of the first 128-bit block given the fact that the maximum instruction length can be 15 bytes.

As a way of example, FIG. 3 demonstratively illustrates a scheme of the decoding buffer after a pre-fetching operation with the assumption that the program-counter (PC) points to a ten-byte instruction that begins at memory location 0x117B3E (and ends at memory location 0x1017B47). The decryption engine (130 in FIG. 2) fetches and decrypts the 128-bit blocks at addresses 0x1017B30 and 0x107B40.

Referring back to FIG. 2b, the instructions retrieved by pre-fetch module 132 are passed to decrypt and validate module 133 wherein the instructions are decrypted. The decryption is performed based on the agreed encryption scheme before encoding. For example, if the agreed encryption scheme is a symmetric key encryption scheme, the decoding process is performed using the same key as the encoding process. If the agreed encryption scheme uses an asymmetric key algorithm (e.g. a public key and a private key), the decoding process is performed with a security key that is different from the security key used in encryption. After decryption, the decoded instructions can be passed to fetch module 136, decode module 138, translate module 140, and next PC module 142 for execution until an end-of-fragment condition is met, that is accomplished by next PC 142 and determining block 128. The end-of-fragment condition is dependent on the particular software dynamic translator being implemented. For many translators, the end-of-fragment condition is met when an application branch instruction is encountered. Other translators may form fragments that emulate only a single application instruction. In any case, when the end-of-fragment condition is met, the context switch restores the application context and the newly translated fragment is executed.

As an alternative feature, embodiments of the invention can be modified so as to remedy the deficiency of current ISR implementation in the art that suffers from code-injection attacks, software tampering, or the like. The current ISR implementation decrypts the injected code and then executes the injected code after the decoding operation. While a crash is somewhat better than allowing an attacker to gain unfettered control, it is still unsatisfactory in executing the injected codes after decoding. At the very least, denial-of-service attacks are possible, and at the worst the execution of garbage code could cause unanticipated actions (particularly with an embedded system that may control over external devices). This problem can be solved by modifying the Diablo (as shown in FIG. 2a) and other static transformation modules when employed to compute the integrity of the target instructions, such as a simple message authentication checksum (MAC) for the first instruction of each basic block in the program. The MAC is inserted at the beginning of each basic block before encryption. When Strata decrypts the target of the branch at decrypt and validate module 133, the MAC is checked at determination module 130. If the code was an injected code (and therefore not properly encrypted), the calculated and stored checksum will be not be equal and the offending code is not executed (126). Of course, other policies can be employed upon detection of: foreign codes (or malicious codes), such as stopping the execution of the foreign codes (especially malicious codes), performing recovery actions, notifying users (systems and/or other parts) of the system that foreign codes haven been detected, or any combinations thereof.

If it is determined (130) that the calculated and stored MAC are identical, the instruction is passed for further process at fetch module, 136, decode module 138, translator module 140, and next PC module 142. It is noted that using Strata can be sufficient to compute a MAC for the first instruction of each basic block only. However, in other embodiments of the present invention method and system, a MAC or perhaps a hash could also be computed on entire blocks of code.

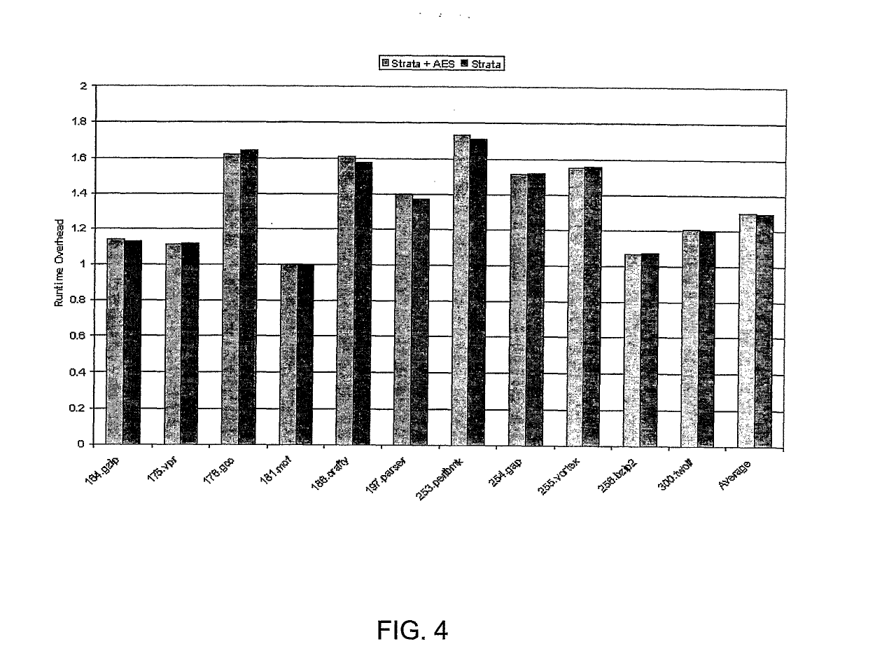

The encryption scheme, including encoding and decoding for protecting software as discussed above has many advantages. For example, while the binary program is padded with no-op instructions (as shown in 116 of FIG. 2), Strata virtual machine discards the padded no-op instructions as Strata builds the fragment. Therefore, there is no runtime overhead incurred from the padding. The decryption step may only occur when a fragment is created. As a consequence, the runtime overhead of the decryption can be amortized over the application's lifetime. An exemplary overhead measurement result of this invention on test programs of the SPECint2000 benchmark is shown in FIG. 4.

Turning to FIG. 4, the runtime results are normalized to native execution—the application running directly on the hardware. The gap between the Strata with and without AES shows that the overhead of applying a strong encryption/decryption scheme such as AES adds little to the runtime overhead by less than 1%. Perlbmk actually runs slightly faster when AES is applied, but this slight speedup is likely from cache effects due to different placement of code by Diablo's alignment of branches and Strata's construction of fragments. The graph shows that the average overhead of our invention is 30%, which is better as compared to an emulation system such as Valgrind in which runtime overheads of 2000% or more are typical.

The software protection method of the invention has many advantages over existing software protection techniques. For example, the software protection method of the invention allows binary programs to be encrypted so that they are difficult to comprehend by an adversary or software attacker who does not have the encryption key either when they are stored on a computer or transmitted between computers. Moreover, the method of the invention breaks the software monoculture by allowing different copies of a binary program on different machines to be encrypted using different keys so that knowledge of how to attack one machine is of no advantage when attacking other machines. To remedy the deficiencies in preventing code-injection attacks in many other software protection techniques, such as ISR, legitimate instruction integrity inspection is employed. As a way of example, a message authentication checksum (hereafter, “MAC”) can be attached to the set of instructions before encoding, and then encoded with the set of instructions. After decoding, the MAC is inspected to exam the integrity of the decoded instructions. In this way, successfully injected codes from attackers can be identified. Such identified foreign codes (or malicious codes) can be discarded and will not be executed.

As an alternative embodiment of the invention, a compiler, such as a language compiler (e.g. C compiler and Java compiler) can be modified, instead of using a link-time optimizer such as Diablo (or any other binary rewriting tool), to generate the encoded binary program, including computing any needed checksums or hash functions over the code, and any needed alignment and padding.

In another alternative embodiment of the invention, the binary program to be protected can be encoded, e.g. encrypted dynamically when the program is first loaded into the memory (instead of statically at compile or link time) using a security key that is also generated at load time. The key can then be passed to Strata virtual machine and used for decryption. An advantage of this approach is that the security key will never be stored on disk but is generated dynamically, e.g. on the fly. Every time a program is restarted, i.e. is reloaded, it would be protected using a different security key.

As yet another alternative embodiment of the invention, shared libraries and Dynamic Link Libraries (DLLs), instead of static libraries, can also be incorporated using this invention. When a shared library or DLL is loaded into memory, it can be encoded, e.g. encrypted, in a similar manner to the software application. The shared library or DLL may be generated in such a manner as to be compatible with the selected encoding/decoding scheme, e.g. processes as padding and alignment are desired to be taken care of (if needed) as with the binary software program. As an option, each shared library may have its own security key for added protection.

As yet another alternative embodiment of the invention, other encoding schemes besides AES can easily be used. A simple example is XOR operation. Any combination of encryption techniques (including both symmetric and asymmetric methods), and message authentication codes or checksums or parity bits can be used. In addition, the encoding scheme can include transforming the original instruction set into a new and potentially unique instruction set, to be decoded by the virtual machine. If desired, obfuscation techniques, such as that disclosed in “Watermarking, tamper-proofing, and obfuscation—tools for software protection”, Collberg, C. S. and C. Thomborson, IEEE Transactions on Software Engineering 28: 735-746 (2002), can be used as part of the encoding process. In general, any encoding schemes that can be decoded at run-time, i.e. when the program runs, can be employed. Of course, it is desirable that the selected encoding and decoding techniques can detect when foreign code (or malicious codes) has been injected to avoid the major problem with existing techniques.

While the embodiments of the invention as discussed above use the Strata virtual machine as an example, other software dynamic translators, interpreters, or emulators can also be used. Other applicable software dynamic translators can be VMW (EMC Corporation, http://www.vmware.com/) and Transitive (Transitive Corporation, http://www.transitive.com/).

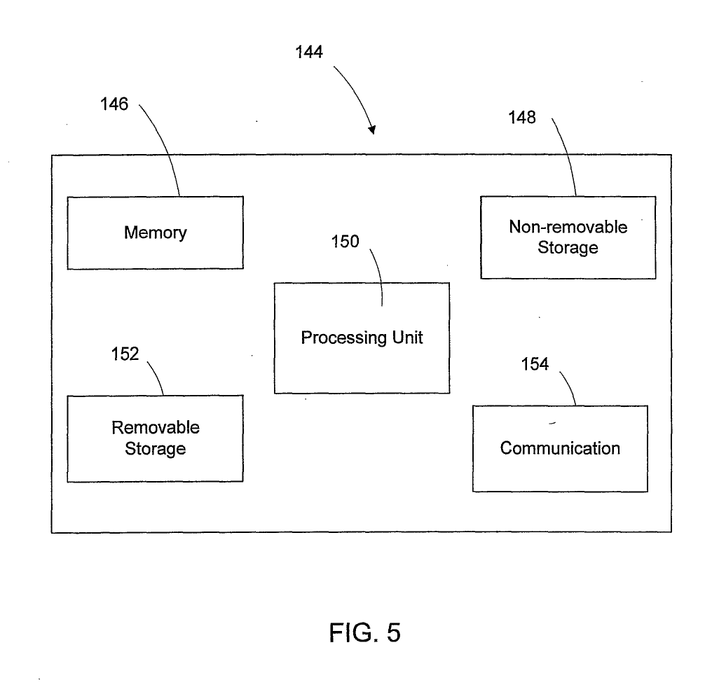

The present invention can be implemented as software in a computing device, or alternatively, on hardware, such as hardware using a processor such as Transmeta Corporation's Crusoe processor. An exemplary computing device in which embodiment of the invention can be implemented is schematically illustrated in FIG. 5. Although such devices are well known to those of skill in the art, a brief explanation will be provided herein for the convenience of other readers.

Referring to FIG. 5, in its most basic configuration, computing device 144 typically includes at least one processing unit 150 and memory 146. Depending on the exact configuration and type of computing device, memory 146 can be volatile (such as RAM), non-volatile (such as ROM, flash memory, etc.) or some combination of the two.

Additionally, device 144 may also have other features and/or functionality. For example, the device could also include additional removable and/or non-removable storage including, but not limited to, magnetic or optical disks or tape, as well as writable electrical storage media. Such additional storage is the figure by removable storage 162 and non-removable storage 148. Computer storage media includes volatile and nonvolatile, removable and non-removable media implemented in any method or technology for storage of information such as computer readable instructions, data structures, program modules or other data. The memory, the removable storage and the non-removable storage are all examples of computer storage media. Computer storage media includes, but is not limited to, RAM, ROM, EEPROM, flash memory or other memory technology CDROM, digital versatile disks (DVD) or other optical storage, magnetic cassettes, magnetic tape, magnetic disk storage or other magnetic storage devices, or any other medium which can be used to store the desired information and which can accessed by the device. Any such computer storage media may be part of, or used in conjunction with, the device.

The device may also contain one or more communications connections 164 that allow the device to communicate with other devices (e.g. other computing devices). The communications connections carry information in a communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication medium includes wired media such as a wired network or direct-wired connection, and wireless media such as eadio, RF, infrared and other wireless media. As discussed above, the term computer readable media as used herein includes both storage media and communication media.

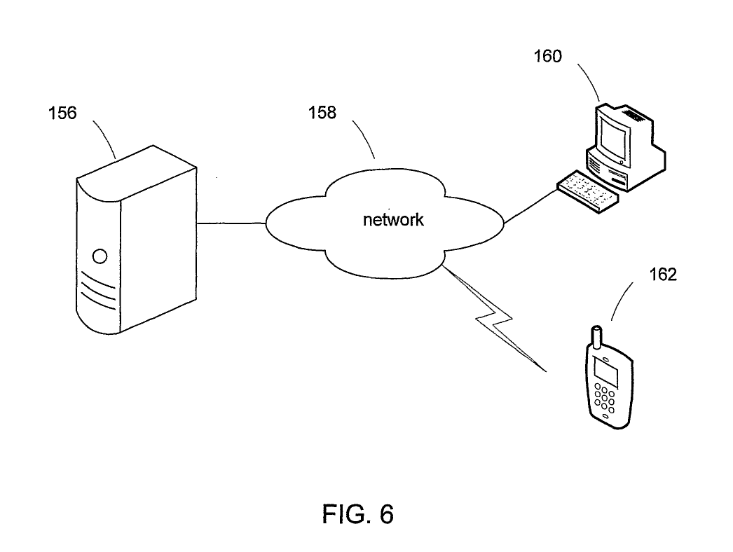

In addition to a stand-alone computing machine, embodiments of the invention can also be implemented on a network system comprising a plurality of computing devices that are in communication with a networking means, such as a network with an infrastructure or an ad hoc network. The network connection can be wired connections or wireless connections. As a way of example, FIG. 6 illustrates a network system in which embodiments of the invention can be implemented. In this example, the network system comprises computer 156 (e.g. a network server), network connection means 158 (e.g. wired and/or wireless connections), computer terminal 160, and PDA (e.g. a smart-phone) 162 (or other handheld or portable device, such as a cell phone, laptop computer, GPS receiver, mp3 player, handheld video player, pocket projector, etc. or handheld devices (or non portable devices) with combinations of such features). The embodiments of the invention can be implemented in anyone of the devices of the system. Specifically, both of the encoding and coding, as well as execution of the instructions can be performed on the same computing device that is anyone of 156, 160, and 162. Alternatively, an embodiment of the invention can be performed on different computing devices of the network system. For example, the encoding process can be performed on one of the computing devices of the network (e.g. server 156), whereas the decoding and execution of the instruction can be performed at another computing device (e.g. terminal 160) of the network system, or vice versa. In fact, the encoding process can be performed at one computing device (e.g. server 156); and the decoding and execution of the instructions can be performed at different computing devices that may or may not be networked. For example, the decoding process can be performed at terminal 160, while the decoded instructions are passed to device 162 where the instructions are executed. This scenario may be of particular value especially when the PDA device accesses to the network through computer terminal 160 (or an access point in an ad hoc network). For another example, software to be protected can be encoded with one or more embodiments of the invention. The encoded software can then be distributed to customers. The distribution can be in a form of storage media (e.g. disk) or electronic copy. For properly executing the encoded software, customers are required to decode the encoded software before execution with proper security keys. Legitimate users or customers can obtain the security keys, for example from the software distributor or directly from the software provider. By this way, illegal usage or illegal copies of software can be prevented.

Embodiments of the invention are also applicable to prevent software tampering. Software tampering can be defined as carrying out unauthorized modifications on software that allows for an adversary to misuse the software in some way. Software tampering can be conducted by adversaries for many reasons, such as changing the software's functionality. For correct operation, all computer systems depend on the use of the software that was designed and built to realize the computer systems' intended purpose. If that software is altered or replaced by an adversary or other third party with malicious intent, the result could be serious. For example, information could be compromised or service could be altered. In a weapon system, an ATM machine, financial software, a “smart” card and similar systems, tremendous damage could be done.

Software tampering can be conducted by adversaries to reverse engineer the software. Software often contains valuable intellectual property that would be useful to an adversary. By stealing a copy of the software and reverse engineering it, the adversary can obtain the intellectual property with little cost.

Software tampering can be conducted by adversaries to change the software's target. In some cases, reverse engineering is not necessary for an adversary to gain value from an existing piece of software, it is often only necessary to execute the software under conditions different from those intended by the software's owners. By stealing a copy and using his or her own target computer, an adversary gains the value of the software without paying for it. This type of malicious behavior is often called piracy. Since software tampering can have serious consequences, the owners and operators of many computer systems desire a mechanism to make tampering as difficult as possible, i.e., they desire their software to be hardened against tampering, and, if possible, made tamperproof.

Tamperproofing software is difficult because the software is often stored at many different locations and often transmitted between locations. A given software system S might be built using hundreds of source-code files that are kept in a file system maintained by S's manufacturer. That file system will usually be shared so that a number of people might have access to the file system and possibly also to all or part of S.

Once the system S is built, it will be in one of several different forms usually referred to as binary and be stored using one of several different media. Supplying the binary form of S to those who will use it might involve physical movement of the media or transmission over a network. The binary software used by a computer is usually stored in a file system that is physically close to that computer. When it is not being used, the software remains available in that file system. When it is being used, the software is also stored in the main memory of the computer using it. An adversary only needs to gain access to the software once in order to tamper with it, and, for some forms of tampering, the access gained need not be to all of the software. If the adversary wants to change the functionality of the software, all that he or she needs to do is gain access to that part of the software which provides the functionality to be changed. Access might be to the source files, the binary files, to the tools that are used to build the software (such as compilers and linkers), to shared libraries that the software uses, or to the software during execution. If the change is not detected, then the adversary has met his or her goal. The number of locations in which the software resides in its various forms makes protecting software from tampering very difficult. The goal of those with a stake in the correct operation of the software is to ensure that the software is protected from tampering in all locations and all in all forms. Protection of the software at the manufacturer's location requires trust in all of those preparing the software. This is similar to any situation in which information is being developed, and so traditional techniques, such as access restriction, can be employed. Beyond the site of the software's original manufacturer, however, the problem of protecting the software against tampering is much harder since most people with access to the software are not known to be trustworthy. The invention described here achieves the stakeholders' goal and defeats all known credible tampering threats. The invention works by encrypting the software using a strong encryption algorithm. The protection that this affords is assured, and it is much more reliable as an anti-tampering technique than software obfuscation approaches. The invention implements anti-tampering efficiently requiring only a small execution overhead, can be applied to virtually any software system, and can be applied retroactively to existing systems.

The invention meets the anti-tampering goal discussed above by maintaining the software in encrypted form until it is executed. The protection provided by encryption can be strong as compared to those in the art because: (1) decryption by an adversary using state-space exploration requires resources that are beyond those available; and (2) decryption by an adversary using the appropriate key or keys is only possible if the key or keys are not protected properly. Existing techniques are available for key distribution and protection. Those software encryption mechanisms in the art, however, either leave the software in plain form to such an extent that the software becomes vulnerable to tampering or the decryption process is extremely inefficient. The invention presented herein addresses both of these problems.

As a way of example, tamperproofing of software can be accomplished by the following steps: (1) the software is encrypted on a host computer in a trusted facility by its owners or the manufacturer prior to its deployment; (2) the software is conveyed to any locations where it is needed in encrypted form; (3) the software is stored on the target computer upon which it is to run in encrypted form; (4) the software is loaded into memory on the target computer in encrypted form; (5) the software is decrypted just prior to execution. Only part of the software is kept in decrypted form at any given time. The decrypted software is held in a protected memory area.

Encryption at the trusted facility can be carried out using an unspecified encryption mechanism. Decryption just prior to execution is effected using an unspecified decryption mechanism. An example of how decryption might be implemented in practice is the use of a supplemental specialized hardware unit of which many are available. Such devices contain the decryption key(s) and the processing hardware that executes the decryption algorithms. Without this device, the encrypted software cannot be decrypted. The keys used for encryption and decryption are made available to the host and target computers using a conventional key management system. An example of how decryption might be controlled is by the use of a dynamic binary translation mechanism. With this approach, each fragment of the software is fetched as needed and sent to the decryption mechanism. The decrypted version of the fragment is stored in a region of memory called a fragment cache and then executed. If the fragment is executed more than once, the originally decrypted version is fetched from the fragment cache provided it is still there. The fragment cache is emptied periodically to ensure that only a small amount of the software is stored in plaintext form.

In order to tamper with the software after it has been encrypted, an adversary would have to either: (1) break the encryption; or (2) tamper with the software during execution. Decrypting the software is as difficult as decrypting any form of encrypted information. Provided the software is free of tampering when it is encrypted, the chances of tampering prior to execution are the same as the chances that the encryption can be broken.

Tampering during execution requires that the adversary gain access to that part of the software maintained in plain text form by the decryption mechanism. Nothing is specified in this invention about the decryption mechanism and so nothing is specified about what parts of the software will be in plain text form at any given point during execution. Using the example of a decryption mechanism given above in which dynamic binary translation is used the only place where the software is maintained in plain text form is the fragment cache. In this example, the fragment cache is protected with a variety of software and hardware mechanisms.

With the method according to embodiment of the invention, changing the software's functionality can be prevented. This form of software tampering is prevented by the fact that the software remains encrypted everywhere that it is stored and during all transmissions prior to execution. Without the decryption key(s), any modification(s) effected by an adversary to the encrypted software would either not survive the decryption process or would be detected.

Reverse engineering the software can also be prevented by the method according to the embodiments of the invention. This form of tampering is prevented by the fact that the software remains encrypted everywhere that it is stored and during all transmissions prior to execution. As a result, the adversary would only be able to acquire an encrypted version of the software. Acquiring the encrypted software does the adversary no good because he or she will not be able to conduct any form of static or dynamic analysis on the software.

Changing the software's target can be prevented by the method according to the embodiments of the invention. This form of tampering is prevented by the fact that the software requires a decryption key in order for it to be executed. Thus, copying the software will not allow it to be executed on an unauthorized target.

Embodiments of the invention are accomplished through encoding and decoding of the software to be protected. The encoding and decoding processes are performed with one or more security keys depending upon the encryption scheme used. The security keys can be managed in multiple ways, as those known in the art. In particular, the decoding key can be delivered with the encoded software, or more preferably, delivered by an alternative means other than that used for delivering the encoded software. In fact, the security keys can also be encrypted before delivery. As a way of example wherein a symmetric key scheme is employed, the security key can be delivered to the customer via an email attachment or a telephone call, while the encoded software can be delivered to the customer via an electronic copy or by mail. In the above, the invention is discussed with reference to encoding and coding instructions associated with the software to be protected. It is readily appreciated by those ordinary skilled in the art that the instructions may or may not be associated with the entire software. Specifically, software can be protected by applying the embodiments to only a portion (or segment) of the software so as to protect the entire software. Specifically, instructions corresponding to only a portion (not entire) of the software can be encoded; while the instructions associated with the entire software are delivered to the customer. At run time, the encoded portion of the instructions is decoded with a decoding scheme corresponding to the encoding scheme during the encoding process; while the instructions not encoded are not included in the decoding process. This encoding-decoding scenario may require that the encoded (and/or the decoded) portion of the entire instructions to be tagged. As another alternative feature, different portions of the software can be encoded/decoded differently. Specifically, the instructions associated with the software may have a first portion that is encoded/decode with a scheme other than the second portion that is encoded/decoded with a different scheme. The instructions may still have the third portion that is not encoded/decoded, but is to be executed along with the decoded instructions. As yet another feature, any one of the first, second, and third portions of instructions may not be consecutive. Instead, encoded instructions (or differently encoded instructions) and un-encoded instructions (if any) can be located anywhere across the entire instruction set associated with the software.

As an alternative feature, the decoded and valid instructions can be removed according to a pre-determined policy so as to enhance the software protection. For example, the decoded and validated instructions can be removed every N^{th} instruction, wherein N is an integer number, such as 1, or more, 10 or more, 100 or more, 1000 or more, and 2000 or more. For another example, the decoded and valid instructions can be removed every X second(s) or more, such as every 1 second or more, 5 seconds or more, 10 seconds or more, and 60 seconds or more. For yet another example, the decoded and valid instructions can be removed after executing a given function more than M times, wherein M is an integer number, such as 1, 2, 3, 4, etc.

If will be appreciated by those of skill in the art that a new and useful method and apparatus for protecting software have been described herein. In view of the many possible embodiments to which the principles of this invention may be applied, however, it should be recognized that the embodiments described herein with respect to the drawing figures are meant to be illustrative only and should not be taken as limiting the scope of invention. Those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

1. A method for protecting software, comprising:
encoding a set of instructions associated with the software using a block encryption technique, wherein the block has more than 8-bits;
decoding the encoded set of instructions; and
executing the decoded set of instructions.

2. The method of claim 1, wherein the block encryption technique is an instruction-set-randomization technique.

3. The method of claim 2, wherein the instruction-set-randomization technique complies with the advanced-encryption-standard.

4. The method of claim 3, wherein the advanced-encryption-standard uses an encoding security key of 128-bits or more.

5. The method of claim 3, wherein the advanced-encryption-standard uses a security key of 256-bits or more.

6. The method of claim 1, wherein the instructions are byte codes, object codes, interpreted codes, or a combination thereof.

7. The method of claim 1, wherein the instructions vary in bit-length.

8. The method of claim 7, wherein the step of encoding further comprises:
padding the instructions with no-op instructions so as to ensure that both encoding and decoding operate on instruction blocks that between the same block boundaries.

9. The method of claim 1, wherein the steps of decoding and executing are performed on a virtual machine.

10. The method of claim 9, wherein the virtual machine comprises a decode engine that is in connection with a buffer.

11. The method of claim 1, wherein the step of decoding further comprises:
decoding the encoded instructions with a decoding key that is the same as the encoding key used for encoding.

12. The method of claim 1, wherein the step of decoding further comprises:
decoding the encoded instructions with a decoding key that is different from the encoding key used for encoding.

13. The method of claim 1, wherein the step of decoding further comprises:
fetching the instructions in consecutive blocks.

14. The method of claim 1, wherein the step of decoding is performed once for its initial execution and the decoded form is retained for a plurality number of subsequent executions.

15. The method of claim 1, wherein the method is performed through a set of binary codes executable by a computing device having a processor.

16. The method of claim 1, wherein the method is performed by plurality of functional modules of software stored in a computing device having a processor.

17. The method of claim 1, wherein both of the encoding and decoding steps are performed on the same computing device.

18. The method of claim 1, wherein the encoding and decoding steps are performed on different computing devices.

19. The method of claim 1, wherein the encoding, decoding, and execution steps are performed on different computing devices.

20. The method of claim 18 wherein the step of encoding is performed on a first computing device; and the step of decoding is performed on a second computing device.

21. The method of claim 20, further comprising:
delivering the encoded instructions to the second computing device.

22. The method of claim 21, wherein the step of delivering is accomplished by a storage device.

23. The method of claim 21, wherein an electronic copy of the encoded instructions is delivered to the second computing device.

24. The method of claim 1, further comprising:
calculating an integrity of at least a portion of the set of instructions;
inserting the integrity into the set of the instructions to be encoded;
encoding the integrity with the instructions; and
validating the instructions by examining the integrity.

25. The method of claim 24, wherein the step of decoding further comprises:
decoding the integrity that is encoded at the encoding step; and
taking an action to the invalid instructions based on a predetermined policy.

26. The method of claim 25, wherein the policy instructs to stop execution of the instructions.

27. The method of claim 25, wherein the policy instructs to recover the system.

28. The method of claim 25, wherein the policy instructs to generate a notification of a foreign instruction.

29. The method of claim 1, wherein the set of instructions is associated with only a portion of the software.

30. The method of claim 29, wherein the software comprises another set of instructions that is not encoded or decoded, but is executed with the set of instructions that is encoded and decoded.

31. The method of claim 1, further comprising:
removing every N^{th} decoded and valid instruction, wherein N is an integer.

32. The method of claim 1, further comprising:
removing the decoded and valid instruction for every 1 or more seconds.

33. The method of claim 1, further comprising:
removing the decoded and valid instruction after execution of a function 1 or more times.

34. The method of claim 1, further comprising:
encoding another set of instructions associated with the software;
decoding said another set of instructions;
combining the decoded another set of instructions with the decoded set of instructions into a reconstructed instruction set; and
executing the reconstructed instructions set.

35. The method of claim 34, wherein a combination of said set of instructions and said another set of instructions constitutes only a portion of the software that further comprises a third portion that is not encoded or decoded, but executed with said decoded set instructions and said another set of decoded instructions.

36. A method for protecting software having a plurality of instructions, comprising:
encoding a first portion of instructions associated with the software with a first encoding scheme;
encoding a second portion of instructions associated with the software with a second encoding scheme;
decoding the first portion of instructions with a first decoding scheme corresponding to the first encoding scheme;
decoding the second portion of instructions with a second decoding scheme corresponding to the second encoding scheme;
reconstructing the plurality of instructions with the decoded first and second set of instructions; and
executing the reconstructed set of instructions.

37. The method of claim 36, wherein the reconstructed set of instructions are identical to the plurality of instructions.

38. The method of claim 36, wherein the first encoding scheme is different from the second encoding scheme.

39. The method of claim 36, wherein one of the first and second encoding schemes employs a symmetric-key encryption scheme.

40. The method of claim 36, wherein one of the first and second encoding schemes employs an asymmetric-key encryption scheme.

41. The method of claim 36, wherein the first and second encoding schemes are the same but with different security keys.

42. The method of claim 36, wherein one of the first and second encoding schemes employs an asymmetric-key encryption scheme, wherein the first and second decoding schemes use different public keys.

43. A system, comprising:
first means for protecting software against execution of a malicious code injected into said software during the execution of said software, comprising:
encoding means for encoding at least a portion of instructions associated; and
decoding means for decoding the encoded instructions; and
second means for executing the instructions associated with the software, comprising:
reconstruction means for reconstructing the instructions of the software based on the decoded instructions; and
a processing unit capable of executing the reconstructed instructions.

44. The system of claim 43, wherein the encoding means encodes the instructions with an AES technique.

45. The system of claim 43, wherein the decoding means comprises a virtual machine.

46. The system of claim 45, wherein the virtual machine comprises a decoding engine.

47. The system of claim 46, wherein the virtual machine is a Strata virtual machine.

48. The system of claim 43, wherein the encoding and decoding means are located at different computing machines, each of which comprises a processing unit.

49. The system of claim 43, wherein the encoding, decoding, and executing means are located at different computing devices.

50. The system of claim 49, wherein the different computing devices are connected by a network.

51. The system of claim 43, wherein the first mans further comprises: means for inserting an integrity to the instruction to be encoded; and wherein the second means further comprises: means for validating the instructions based on the integrity after decoding.

52. The system of claim 43, wherein the second means further comprises:
means for taking actions to invalidated instructions based on a predetermined policy.

53. The system of claim 52, wherein the policy comprises a statement of stopping execution of the invalid instructions.

54. The system of claim 52, wherein the policy comprises a statement of recovering the system upon reception of the invalid instructions.

55. The system of claim 52, wherein the policy comprises a statement of notifying the system of the invalid instructions.

56. The system of claim 43, wherein the first means is capable of protecting software against discovery of its mechanism.

57. The system of claim 43, wherein the first means is capable of protecting software against malicious changes to the intended operational target of the software.

58. The system of claim 43, wherein the first means is capable of protecting software against software tampering.

59. A method of executing a set of encoded instructions, comprising:
loading the set of encoded instructions into a virtual machine;
decoding the instructions; and
executing the decoded instructions by the virtual machine or a computing device on which the virtual machine is hosted.

60. The method of claim 59, wherein the step of decoding further comprises:
decoding the instructions with a decoding key that is the same as an encoding key used in encoding the instructions.

61. The method of claim 59, wherein the step of decoding further comprises:
decoding the instructions with a decoding key that is different from an encoding key used in encoding the instructions.

62. The method of claim 59, wherein the virtual machine is a Strata virtual machine comprising a decoding engine and a buffer that is in connection with the decoding engine.

63. A computer-readable medium having computer-executable instructions for performing a method for protecting software as set forth in claim 1.

64. A computing device, comprising:
a computer-readable medium as set forth in claim 63; and
a processor capable of executing the computer-executable instructions.

65. A system, comprising:
a first computing device having a first computer-executable instructions for performing a method as set forth in claim 1;
a second computing device having a second computer-executable instructions for performing a method as set forth in claim 1; and
wherein the first and second computing devices are connected through a network.

66. The system of claim 65, wherein the network has a pre-defined infrastructure.

67. The system of claim 65, wherein the network is an ad hoc network.

68. A system, comprising:
a first computing device having a first computer-executable instructions for performing a method comprising:
encoding a set of instructions associated with the software using a block
encryption technique, wherein the block has a more than 32-bits;
a second computing device having a second computer-executable instructions for performing a method comprising:
executing the encoded set of instructions.

69. The system of claim 68, wherein the first and second computers are networked.

70. The system of claim 68, wherein the first and second computers are not connected.

71. The system of claim 69, wherein the network has a pre-defined infrastructure.

72. The system of claim 69, wherein the network is an ad hoc network.

73. The system of 68, wherein the block encryption technique is an instruction-set-randomization technique.

74. The system of claim 73, wherein the instruction-set-randomization technique complies with the advanced-encryption-standard.

75. The system of claim 74, wherein the advanced-encryption-standard uses an encoding security key of 128-bits or more.

76. The system of claim 68, wherein the instructions are byte codes, object codes, or a combination thereof.

77. The system of claim 68, wherein the instructions vary in bit-length.

78. The system of claim 77, further comprising:
padding the instructions with no-op instructions so as to ensure that both encoding and decoding operate on instruction blocks that between the same block boundaries.

79. The system of claim 68, wherein the step of executing is performed on a virtual machine.

80. The system of claim 79, wherein the virtual machine comprises a decode engine that is in connection with a buffer.

81. The system of claim 80, further comprising:
decoding the encoded instructions with a decoding key that is the same as the encoding key used for encoding.

82. The system of claim 80, further comprising:
decoding the encoded instructions with a decoding key that is different from the encoding key used for encoding.

83. The system of claim 80, wherein the step of decoding further comprises:
fetching the instructions in consecutive blocks.

84. The system of claim 80, wherein the step of decoding is performed once for its initial execution and the decoded form is retained for a plurality number of subsequent executions

85. The system of claim 68, wherein the method is performed through a set of binary codes executable by a computing device having a processor.

86. The system of claim 68, wherein the method is performed by plurality of functional modules of software stored in a computing device having a processor.

87. The system of claim 68, further comprising:
calculating an integrity of at least a portion of the set of instructions;
inserting the integrity into the set of the instructions to be encoded;
encoding the integrity with the instructions; and
validating the instructions by examining the integrity.

88. A method for protecting software, comprising:
retrieving a set of instructions associated with the software;
calculating an integrity of at least a portion of the set of instructions;
inserting the integrity to the instructions;
encoding the instructions and the integrity with an encoding key; and
executing the instructions, further comprising:
decoding the instructions and integrity;
validating the instructions based by examining the integrity; and
executing the decoded instructions if the instructions are valid.

89. A method for resisting execution of malicious codes during execution of a set of legitimate instructions of software, the method comprising:
tagging the set of legitimate instruction, comprising:
inserting an integrity for at least a portion of the legitimate instructions to the set of instructions; and
encoding at least a portion of the set of instructions and the integrity;
executing the instructions, comprising:
decoding the encoded instructions and the integrity inserted therein;
validating the decoded instructions by examining the decoded integrity; and
executing the instructions if the decoded instructions are valid.

90. The method of claim 89, further comprising:
discarding the instructions if the decoded instructions are invalid.

91. A computing device, comprising:
a virtual machine that further comprises: a processor, and a decoding engine in connection with the processor, said decode engine being capable of decoding a set of computer-executable instructions according to a decoding scheme.

92. The device of claim 91, wherein the virtual machine is a Strata virtual machine incorporated therein the decoding engine.

93. The device of claim 91, wherein the decoding is performed in compliance with an AES encoding and decoding scheme.

94. The method of claim 1, wherein the block has more than 16-bits.

95. The method of claim 94, wherein the block has more than 32-bits.

96. The method of claim 1, wherein the block has more than 64-bits.
